(19) United States
(12) Patent Application Publication
(10) Pub. No.: US 2022/0176366 A1
(43) Pub. Date: Jun. 9, 2022

(54) Compositions Comprising Nanoparticles and Processes for Making Nanoparticles

(71) Applicant: ExxonMobil Chemical Patents Inc., Baytown, TX (US)

(72) Inventors: Joshua J. Willis, Houston, TX (US); Jeffrey C, Bunquin, Houston, TX (US); Stephanie M Westbrook, Krmah, TX (US); Antonie Jan Bons, Vlaams-Brabant (BE); Joseph A. Thnockmorton, Kingwood, TX (US); Javier Guzman, Porter, TX (US); Renyuan Yu, Humble, TX (US)

(21) Appl. No.: 17/442,843

(22) PCT Filed: Mar. 27, 2020
(86) PCT No.: PCT/US2020/025182

§ 371 Date: Sep. 24, 2021

Related U.S. Application Data
(60) Provisional application No. 62/826,019, filed on Mar. 29, 2019.

(30) Foreign Application Priority Data
May 28, 2019 (EP) 19176977.7

(51) Int. Cl. B01J 35/00; B01J 35/02; B01J 37/08; B01J 37/02

(52) U.S. Cl. CPC B01J 35/0013; B01J 35/006; B82Y 30/00; B01J 37/086; B01J 37/0236; B01J 35/026

(57) ABSTRACT

The present disclosure relates to nanoparticle compositions, catalyst compositions, processes for making nanoparticle compositions and processes for making catalyst compositions. In at least one embodiment, a composition includes a plurality of nanoparticles, where each nanoparticle includes a kernel, the kernels include at least one metal element and oxygen, and the kernels have an average particle size from 4 to 100 nanometers, and a particle size distribution of less than 20%.

### CROSS-REFERENCE TO RELATED APPLICATIONS

This application claims priority to and the benefit of U.S. Provisional Application No. 62/826,019, filed Mar. 29, 2019, and European Patent Application No. 19176977.7, filed May 28, 2019, the disclosures of which are incorporated herein by their reference.

### FIELD

The present disclosure relates to nanoparticle compositions, catalyst compositions, processes for making nanoparticle compositions and processes for making catalyst compositions. This disclosure is useful, e.g. in production of metal oxide nanoparticles and production of catalyst compositions by calcining the metal oxide nanoparticles on a support.

### BACKGROUND

The development of monodisperse and crystalline nanoparticles of metals, alloys, metal oxides and multi-metallic oxides have been sought after for not only their fundamental scientific interests, but also many potential technological and practical applications in areas such as ultra-high density magnetic data storage media, biomedical labeling reagents, drug delivery materials, nanoscale electronics, highly efficient laser beam sources, highly bright optical devices, MRI enhancing agents, and catalysis. Nonetheless, methods for obtaining such nanoparticles have not been well suited for large scale and inexpensive production sufficient for industrial applications.

Supported heterogeneous catalysts may be composed of an active phase nanoparticle and possible secondary and tertiary promoter nanoparticles supported on a high surface area support. Supported heterogeneous catalysts may be valuable to a wide variety of catalytic reactions, such as combustion, hydrogenation, or Fischer-Tropsch synthesis. Many reactions are structure sensitive such that the activity, stability, and selectivity are strongly dependent on the crystal structure, phase, and size of the supported active phase nanoparticles. Current industrial techniques for supported catalyst synthesis are unable to effectively control the active phase size, and shape with high precision (<20% standard deviation in size), as well as, successfully incorporate secondary and tertiary metals into the active phase uniformly for promotion of activity, stability, and selectivity.

Advances in colloidal chemistry have resulted in the synthesis of metal and metal oxide nanoparticles. However, previous synthetic methods do not produce nanoparticles of uniform size and/or shape, are not scalable for industrial application, involve complicated procedures, require (e.g., not merely optional) the use of obscure and/or exotic precursors, require (e.g., not merely optional) addition of surfactants, produce nanoparticles of low crystallinity, and require (e.g., not merely optional) the use of multiple reaction vessels.

There is a need for a scalable and simple synthesis of size, shape, and composition controlled mixed metal oxide nanoparticles as supported catalyst precursors for a variety of reactions.

References for citing in an information disclosure statement (37 C.F.R 1.97(h)): U.S. Pat. Nos. 7,128,891; 7,407,572; 7,867,556; U.S. Patent Publication Nos. 2006/0133990

### SUMMARY

One possible solution is pre-forming size-, shape-, and composition-controlled nanoparticles and subsequently dispersing the nanoparticles onto support materials. It has been discovered that metal oxide nanoparticles can be produced that have one or more of the following characteristics: crystalline, uniform particle size, uniform particle shape, uniform distribution of metals within a nanoparticle, dispersability in hydrophobic solvents and on supports, and control of both size and shape. Furthermore, it has been discovered that metal oxide nanoparticles can be produced in a single reaction vessel with readily available precursors.

A first aspect of this disclosure relates to a composition including a plurality of nanoparticles, where each nanoparticle includes a kernel, the kernels include at least one metal element and oxygen, and the kernels have an average particle size from 4 to 100 nanometers, and a particle size distribution of less than 20%.

A Second aspect of this disclosure relates to processes for making a composition including a plurality of nanoparticles, where the nanoparticles include an oxide of at least one metal element, and the process comprises: providing a first dispersion system at a first temperature, the first dispersion system including a salt of a long-chain organic acid of the at least one metal element, a long-chain hydrocarbon solvent, optionally a salt of a second organic acid of the at least one metal element, optionally sulfur or an organic sulfur compound soluble in the long-chain hydrocarbon solvent, and optionally an organic phosphorus compound soluble in the long-chain hydrocarbon solvent; and heating the first dispersion system to a second temperature higher than the first temperature but no higher than the boiling point of the long-chain hydrocarbon solvent, where at least a portion of the salt of the long-chain organic acid and at least a portion of the salt of the second organic acid, if present, to form a second dispersion system including nanoparticles dispersed in the long-chain hydrocarbon solvent, and the nanoparticles include kernels, and the kernels include the at least one metal element, oxygen, optionally sulfur, and optionally phosphorus.

A third aspect of this disclosure relates to a process for making a catalyst composition, the process including: providing the composition including a plurality of nanoparticles, where each nanoparticle includes a kernel, the kernels include at least one metal element and oxygen, and the kernels have an average particle size from 4 to 100 nanometers, and a particle size distribution of less than 20%; contacting the composition with a support to disperse the nanoparticles on the surface of the support; and drying and/or calcining the support to obtain the catalyst composition including the support and a catalytic component on the surface of the support, the catalytic component including the at least one metal, oxygen, optionally sulfur, and optionally phosphorous.

### BRIEF DESCRIPTION OF THE DRAWINGS

FIG. 1 is a graph showing particle size distributions of MnO nanoparticles synthesized with differing concentrations of Mn, according to an embodiment.

FIG. 2. is a graph showing particle size distributions of MnCoOₓ nanoparticles synthesized from precursors under different pressures, according to an embodiment.

FIG. 3 is a graph showing an energy dispersive X-ray spectrum of MnCoOₓ nanoparticles, according to an embodiment.

FIG. 4 is a graph showing length and width distributions for MnCoOₓ rod-shaped nanoparticles, according to an embodiment.

FIG. 5. is a graph showing an energy dispersive X-ray spectrum of MnCoOₓ rod-shaped nanoparticles, according to an embodiment.

FIG. 6. is a graph showing wide-angle X-ray scattering (“WAXS”) of spherical and rod-shaped MnCoOₓ nanoparticles, according to two embodiments, with reference peaks of MnO and CoO, according to an embodiment.

### DETAILED DESCRIPTION

In this disclosure, a process is described as comprising at least one “step.” It should be understood that each step is an action or operation that may be carried out once or multiple times in the process, in a continuous or discontinuous fashion. Unless specified to the contrary or the context clearly indicates otherwise, multiple steps in a process may be conducted sequentially in the order as they are listed, with or without overlapping with one or more other step, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the numerical values used in the specification and claims constitute specific embodiments. Efforts have been made to ensure the accuracy of the data in the examples. However, it should be understood that any measured data inherently contain a certain level of error due to the limitation of the technique and equipment used for making the measurement.

As used herein, the indefinite article “a” or “an” shall mean “at least one” unless specified to the contrary or the context clearly indicates otherwise. Thus, embodiments including “a metal” include embodiments including one, two, or more metals, unless specified to the contrary or the context clearly indicates only one metal is included.

For the purposes of this disclosure, the nomenclature of elements is pursuant to the version of Periodic Table of Elements as described in CHEMICAL AND ENGINEERING NEWS, 63(5), pg. 27 (1985). Abbreviations for atoms are as given in the periodic table (Li=lithium, for example).

The following abbreviations may be used herein for the sake of brevity: RT is room temperature (and is 23° C. unless otherwise indicated), kPag is kilopascal gauge, psig is pound-force per square inch gauge, psia is pound-force per square inch absolute, and WHSV is weight hourly space velocity, and GHSV is gas hourly space velocity. Abbreviations for atoms are as given in the periodic table (Co=cobalt, for example).

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of this disclosure. Additionally, they do not exclude impurities and variances normally associated with the elements and materials used. “Consisting essentially of” a component in this disclosure can mean, e.g., comprising, by weight, at least 80 wt %, of the given material, based on the total weight of the composition comprising the component.

For purposes of this disclosure and claims thereto, the term “substituted” means that a hydrogen atom in the compound or group in question has been replaced with a group or atom other than hydrogen. The replacing group or atom is called a substituent. Substituents can be, e.g., a substituted or unsubstituted hydrocarbyl group, a heteroatom, a heteroatom-containing group, and the like. For example, a “substituted hydrocarbyl” is a group derived from a hydrocarbyl group made of carbon and hydrogen by substituting at least one hydrogen in the hydrocarbyl group with a non-hydrogen atom or group. A heteroatom can be nitrogen, sulfur, oxygen, halogen, etc.

The terms “hydrocarbyl,” “hydrocarbyl group,” or “hydrocarbyl radical” interchangeably mean a group consisting of carbon and hydrogen atoms. For purposes of this disclosure, “hydrocarbyl radical” is defined to be C1-C100 radicals, that may be linear, branched, or cyclic, and when cyclic, aromatic or non-aromatic.

The term melting point (mp) refers to the temperature at which solid and liquid forms of a substance can exist in equilibrium at 760 mmHg.

The term boiling point (bp) refers to the temperature at which liquid and gas forms of a substance can exist in equilibrium at 760 mmHg.

“Soluble” means, with respect to a given solute in a given solvent at a given temperature, at most 100 mass parts of the solvent is required to dissolve 1 mass part of the solute at RT and under a pressure of 1 atmosphere. “Insoluble” means, with respect to a given solute in a given solvent at a given temperature, more than 100 mass parts of the solvent is required to dissolve 1 mass part of the solute at RT and under a pressure of 1 atmosphere.

The term “branched hydrocarbon” means a hydrocarbon including at least 4 carbon atoms and at least one carbon atom connecting to three carbon atoms.

The terms “alkyl,” “alkyl group,” and “alkyl radical” interchangeably mean a saturated monovalent hydrocarbyl group. A “cyclic alkyl” is an alkyl including at least one cyclic carbon chain. An “acyclic alkyl’ is an alkyl free of any cyclic carbon chain therein. A “linear alkyl” is an acyclic alkyl having a single unsubstituted straight carbon chain. A “branched alkyl” is an acyclic alkyl including at least two carbon chains and at least one carbon atom connecting to three carbon atoms. Examples of alkyl groups can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like including their substituted analogues.

The term “Cn” compound or group, where n is a positive integer, means a compound or a group including carbon atoms therein at the number of n. Thus, a “Cm to Cn” alkyl means an alkyl group including carbon atoms therein at a number in a range from m to n, or a mixture of such alkyl groups. Thus, a C1-C3 alkyl means methyl, ethyl, n-propyl, or 1-methylethyl. The term “Cn+” compound or group, where n is a positive integer, means a compound or a group including carbon atoms therein at the number of equal to or greater than n. The term “Cn−” compound or group, where n is a positive integer, means a compound or a group including carbon atoms therein at the number of equal to or lower than n.

The term “conversion” refers to the degree to which a given reactant in a particular reaction (e.g., dehydrogenation, hydrogenation, etc.) is converted to products. Thus 100% conversion of carbon monoxide means complete consumption of carbon monoxide, and 0% conversion of carbon monoxide means no measurable reaction of carbon monoxide.

The term “selectivity” refers to the degree to which a particular reaction forms a specific product, rather than another product. For example, for the conversion of syngas, 50% selectivity for C1-C4 alcohols means that 50% of the products formed are C1-C4 alcohols, and 100% selectivity for C1-C4 alcohols means that 100% of the products formed are C1-C4 alcohols. The selectivity is based on the product formed, regardless of the conversion of the particular reaction.

The term “nanoparticle” means a particle having a largest dimension in the range from 0.1 to 500 nanometers.

The term “long-chain” means comprising a straight carbon chain having at least 8 carbon atoms excluding any carbon atoms in any branch that may be connected to the straight carbon chain. Thus, n-octane and 2-octain are long-chain alkanes, but 2-methylheptane is not. A long-chain organic acid is an organic acid comprising a straight carbon chain having at least 8 carbon atoms excluding any carbon atoms in any branch that may be connected to the straight carbon chain. Thus, octanoic acid is a long-chain organic acid, but 6-methylheptanoic acid is not.

The term “organic acid” means an organic Bronsted acid capable of donating a proton. Organic acids include, carboxylic acids of any suitable chain length; carbon containing sulfinic, sulfonic, phosphinic, and phosphonic acids; hydroxamic acids, and in some embodiments, amidines, amides, imides, alcohols, and thiols.

The term “surfactant” means a material capable of reducing the surface tension of a liquid in which it is dissolved. Surfactants can find use in, for example, detergents, emulsifiers, foaming agents, and dispersants.

Detailed description of the nanoparticles and catalyst compositions of this disclosure, including the composition including nanoparticles of the first aspect, the process for producing nanoparticles of the second aspect, and the catalyst composition of the third aspect of this disclosure, is provided below.

### Kernel Characteristics

A nanoparticle may be present as a discreet particle dispersed in a media such as a solvent, e.g., a hydrophobic solvent such as toluene in certain embodiments. Alternatively, a nanoparticle may be stacked next to a plurality of other nanoparticles in the composition of this disclosure. A nanoparticle in the nanoparticle composition of this disclosure comprises a kernel which are observable under a transmission electron microscope. The nanoparticle may in certain embodiments further comprises one or more long-chain groups attached to the surface thereof. Alternatively, a nanoparticle may consist essentially of, or consist entirely of a kernel only.

A kernel in a nanoparticle can have a largest dimension in a range of from 4 nanometers to 100 nanometers. Kernels may have a near spherical or elongated shape (e.g. rod-shaped). Kernels that are elongated may have an aspect ratio of from 1 to 50, such as from 1.5 to 30, from 2 to 20, from 2 to 10, or from 3 to 8. The aspect ratio is the length of a longer side of the kernel divided by the length of a shorter side of the kernel. For example, a rod-shaped kernel of diameter 4 nm and length of 44 nanometers has an aspect ratio of 11.

The kernels of the nanoparticles in the nanoparticle compositions of this disclosure may have a particle size distribution of 20% or less. The particle size distribution is expressed as a percentage of the standard deviation of the particle size relative to the average particle size. For example, a plurality of kernels that have an average size of 10 nanometers and a standard deviation of 1.5 nanometers has a particle size distribution of 15%. The kernels of the nanoparticles in the nanoparticle compositions of this disclosure may have an average particle size of 4 nm to 100 nm, such as 4 nm to 35 nm, or 4 nm to 20 nm.

Particle size distribution is determined by Transmission Electron Microscopy (“TEM”) measurement of nanoparticles deposited on a flat solid surface.

The kernels of the nanoparticles in the nanoparticle compositions of this disclosure may be crystalline, semi-crystalline, or amorphous in nature.

Kernels are composed of at least one metal element. The at least one metal may be selected from groups 1, 2, 3, 4, 5, 6, 11, 12, 13, 14, and 15, Mn, Fe, Co, Ni, or W, and combinations thereof. Where the at least one metal element includes two or more metals, the metals are designated as M1, M2, and M3, according to the number of metal elements. M1 may be selected from manganese, iron, cobalt, combinations of iron and cobalt at any proportion, combinations of iron and manganese at any proportion, combinations of cobalt with manganese at any proportion, and combinations of iron, cobalt, and manganese at any proportion. In specific embodiments, M1 is a single metal of manganese, cobalt, or iron. Where M1 includes a binary mixture/combination of cobalt and manganese, cobalt may be present at a higher molar proportion than manganese. Where M1 includes a binary mixture/combination of iron and manganese, iron may be present at a higher molar proportion than manganese. Without intending to be bound by a particular theory, it is believed that the presence of M1 provides at least a portion of the catalytic effect of the catalyst compositions.

M2 may be selected from groups 4, 5, 6, 11, 12, and Ni. M2 may be selected from nickel, zinc, copper, molybdenum, tungsten, and silver. Without intending to be bound by a particular theory, it is believed that the presence of M2 promotes the catalytic effect of M1 in the catalyst compositions.

The presence of M3 in the compositions of this disclosure is optional. If present, M3 may be selected from a metal of Groups 1, 2, 3, 13, 14, 15, and the lanthanide series. M3 may be selected from alkali metals, Y, Sc, a lanthanide, and a metal from groups 13, 14, or 15, and any combination(s) and mixture(s) of two or more thereof at any proportion. In certain embodiments, M3 is selected from aluminum, gallium, indium, thallium, scandium, yttrium, and the lanthanide series. In some embodiments, M3 is selected from gallium, indium, scandium, yttrium, and a lanthanide. Lanthanides may include: La, Ce, Pr, Nd, Gb, Dy, Ho, and Er. Without intending to be bound by a particular theory, it is believed the presence of metal M3 can promote the catalyst effect of the catalyst compositions.

Kernels are further composed of oxygen forming a metal oxide. The presence of a metal oxide can be indicated by the XRD graph of the nanoparticle composition. By a “metal oxide,” it is meant to include oxide of a single metal, or a combination of two or more metals M1, M2, and/or M3. Suitably the kernel may include an oxide of a single metal, or a combination of two or more metals of M1 and/or M2. Suitably the kernel may include an oxide of a single metal, or a combination of two or more metals of M¹. In at least one embodiment, the catalytic component may include one or more of iron oxide, cobalt oxide, manganese oxide, (mixed iron cobalt) oxide, (mixed iron manganese) oxide, mixed (cobalt manganese) oxide, and mixed (cobalt, iron, and manganese) oxide. In at least one embodiment, the kernel may include an oxide of a single metal, or a combination of two or more metals of M2 (e.g., yttrium and the lanthanides). The kernel may include an oxide of a metal mixture including an M1 metal and an M2 metal. The identification of the presence of an oxide phase in a nanoparticle can be conducted by comparing the XRD data of the nanoparticle against an XRD peak database of oxides, such as those available from International Center for Diffraction Data (“ICDD”).

The kernel compositions of this disclosure may optionally include sulfur in the kernel. Without intending to be bound by a particular theory, in certain embodiments, the presence of sulfur can promote the catalytic effect of the catalyst composition created from the nanoparticle compositions including kernels. The sulfur may be present as a sulfide of one or more metals of M1, M2, and/or M3.

The kernel compositions of this disclosure may optionally include phosphorus in the kernel. Without intending to be bound by a particular theory, in certain embodiments, the presence of phosphorus can promote the catalytic effect of the catalyst composition created from the nanoparticle compositions including kernels. The phosphorus may be present as a phosphide of one or more metals of M1, M2, and/or M3.

In specific embodiments, the kernel of a nanoparticle composition of this disclosure consists essentially of M1, M2, M3, oxygen, optionally sulfur, and optionally phosphorus e.g., including ≥85, or ≥90, or ≥95, or ≥98, or even ≥99 wt % of M1, M2, M3, oxygen, optionally sulfur, and optionally phosphorus based on the total weight of the kernel.

The molar ratios of M2 to M1 (referred to as r1), M3 to M1 (referred to as r2), oxygen to M1 (referred to as r3), sulfur to M1 (referred to as r4), and phosphorus to M1 (referred to as r5) in the kernel of a nanoparticle composition of this disclosure are calculated from the aggregate molar amounts of the elements in question. Thus, if M1 is a combination/mixture of two or more metals, the aggregate molar amount of all metals of M1 is used for calculating the ratios. If M2 is a combination/mixture of two or more metals, the aggregate molar amounts of all metals M2 is used for calculating the ratio r1. If M3 is a combination/mixture of two or more metals, the aggregate molar amounts of all metals M3 is used for calculating the ratio r2.

The molar ratio of M2 to M1 in the kernel of a nanoparticle composition of this disclosure, r1, can be from r1a to r1b, where r1a and r1b can be, independently, e.g., 0, 0.05, 0.1, 0.2, 0.3, 0.4, 0.5, 0.6, 0.7, 0.8, 0.9, 1, 1.1, 1.2, 1.3, 1.4 or 1.5, as long as r1a<r1b. In some embodiments, r1a=0, r1b=2; such as r1a=0, r1b=0.5; or r1a=0.05, r1b=0.5. In at least one embodiment, r1 is in the vicinity of 0.5 (e.g., from 0.45 to 0.55), meaning that M1 is present in the kernel at substantially twice the molar amount of M2.

The molar ratio of M3 to M1 in the kernel of a nanoparticle compositions of this disclosure, r2, can be from r2a to r2b, where r2a and r2b can be, independently, e.g., 0, 0.005, 0.01, 0.05, 0.1, 0.2, 0.3, 0.4, or 0.5, as long as r2a <r2b. In some embodiments, r2a=0, r2b=5; such as r2a=0.005, r2b=0.5.Thus M3, if present, is at a substantially lower molar amount than M1.

The molar ratio of oxygen to M1 in the kernel of a nanoparticle composition of this disclosure, r3, can be from r3a to r3b, where r3a and r3b can be, independently, e.g., 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5, as long as r3a<r3b. In some embodiments, r3a=0.05, r3b=5; such as r3a=0.5, r3b=4; or r3a=1, r3b=3.

The molar ratio of sulfur to M1 in the kernel of a nanoparticle composition of this disclosure, r4, can be from r4a to r4b, where r4a and r4b can be, independently, e.g., 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5, as long as r4a<r4b. In some embodiments, r4a=0, r4b=5; such as r4a=0, r4b=2.

The molar ratio of phosphorus to M1 in the kernel of a nanoparticle composition of this disclosure, r5, can be from r5a to r5b, where r5a and r5b can be, independently, e.g., 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5, as long as r5a<r5b. In some embodiments, r5a=0, and r5b=5; such as r5a=0 and r5b=2.

In specific embodiments, the metal(s) M1 can be distributed substantially homogeneously in the kernel. Additionally and/or alternatively, the metal(s) M2 can be distributed substantially homogeneously in the kernel. Additionally and/or alternatively, the metal(s) M3 can be distributed substantially homogeneously in the kernel. Additionally and/or alternatively, oxygen can be distributed substantially homogeneously in the kernel. Still additionally and/or alternatively, sulfur can be distributed substantially homogeneously in the kernel. Additionally and/or alternatively, phosphorus can be distributed substantially homogeneously in the kernel.

It is highly advantageous that the metal oxide(s) are highly dispersed in the kernel. The metal oxide(s) can be substantially homogeneously distributed in the kernel, resulting in a highly dispersed distribution, which can contribute to a high catalytic activity of the catalytic composition including nanoparticle compositions that include kernels.

The nanoparticle composition of this disclosure may include or consist essentially of the kernel of this disclosure, e.g., including ≥85, or ≥90, or ≥95, or ≥98, or even ≥99 wt % of the kernel, based on the total weight of the nanoparticle composition. The nanoparticle composition of the present disclosure may include long-chain hydrocarbyl groups disposed on (e.g., attached to) the kernel.

### Nanoparticle Formation

The nanoparticle composition, of this disclosure may be produced from a first dispersion system at a first temperature (T1). A first dispersion system includes a long-chain hydrocarbon solvent, a salt of a long-chain organic acid and the at least one metal element, optionally sulfur or an organic sulfur compound (which can be soluble in the long-chain hydrocarbon solvent), and optionally an organic phosphorus compound (which can be soluble in the long-chain hydrocarbon solvent). The salt of a long-chain organic acid and the at least one metal element may be formed in situ with a salt of a second organic acid and the at least one metal element, and a long-chain organic acid.

The T1 may include temperatures from T1a to T1b, where T1a and T1b can be, independently, e.g., 0, RT, 35, 40, 45, 50, 75, 100, 125, 150, 175, 200, 225, 250, 275, or 300° C., as long as T1a<T1b, such as T1a=RT, T1b=250° C.; or T1a=35° C., T1b=150° C. The first temperature may be maintained for from 10 min to 100 hours, such as from 10 min to 10 hours, 10 minutes to 5 hours, 10 minutes to 3 hours, or 10 minutes to 2 hours. The first dispersion system may be held under inert atmosphere or under pressure reduced below atmospheric pressure. For example, the first dispersion system may be maintained under flow of nitrogen or argon, and alternatively, may be attached to a vacuum reducing the pressure to less than 760 mmHg, such as less than 400 mmHg, less than 100 mmHg, less than 50 mmHg, less than 30 mmHg, less than 20 mmHg, less than 10 mmHg, or less than 5 mmHg The choice of maintaining the first dispersion system under flow of inert gas versus reduced pressure may affect the size of the nanoparticles produced. Without being limited by theory, it is possible that a first dispersion system under reduced pressure has fewer contaminants and byproducts than if it was maintained under flow of inert gas and the fewer contaminants may allow for formation of smaller nanoparticles.

The long-chain hydrocarbon solvent may include saturated and unsaturated hydrocarbons, aromatic hydrocarbons, and hydrocarbon mixture(s).

Some example saturated hydrocarbons suitable for use as the long-chain hydrocarbon solvent are C12+ hydrocarbons, such as C12 to C24 hydrocarbons, such as C14 to C24, C16 to C22, C16 to C20, C16 to C18 hydrocarbons, such as n-dodecane (mp −10° C., bp 214° C. to 218° C.), n-tridecane (mp −6° C., bp 232° C. to 236° C.), n-tetradecane (mp 4° C. to 6° C., bp 253° C. to 257° C.), n-pentadecane (mp 10° C. to 17° C., bp 270° C.), n-hexadecane (mp 18° C., bp 287° C.), n-heptadecane (mp 21° C. to 23° C., bp 302° C.), n-octadecane (mp 28° C. to 30° C., bp 317° C.), n-nonadecane (mp 32° C., bp 330° C.), n-icosane (mp 36° C. to 38° C., bp 343° C.), n-henicosane (mp 41° C., bp 357° C.), n-docosane (mp 42° C., bp 370° C.), n-tricosane (mp 48° C. to 50° C., bp 380° C.), n-tetracosane (mp 52° C., bp 391° C.), or mixture(s) thereof.

Some example unsaturated hydrocarbons suitable for use as the long-chain hydrocarbon solvent include C12+ unsaturated unbranched hydrocarbons, such as C12 to C24, C14 to C24, C16 to C22, C16 to C20, C16 to C18 unsaturated unbranched hydrocarbons (the double-bond may be cis or trans and located in any of the 1,2,3,4,5,6,7,8,9,10,11, or 12 positions), such as 1-dodecene (mp −35° C., bp 214° C.), 1-tridecene (mp −23° C., bp 232° C. to 233° C.), 1-tetradecene (mp −12° C., bp 252° C.), 1-pentadecene (mp −4° C., bp 268° C. to 239° C.), 1-hexadecene (mp 3° C. to 5° C., bp 274° C.), 1-heptadecene (mp 10° C. to 11° C., bp 297° C. to 300° C.), 1-octadecene (mp 14° C. to 16° C., bp 315° C.), 1-nonadecene (mp 236° C., bp 329° C.), 1-icosene (mp 26° C. to 30° C., bp 341° C.), 1-henicosene (mp 33° C., bp 353° C. to 354° C.), 1-docosene (mp 36° C. to 39° C., bp 367° C.), 1-tricosene (bp 375° C. to 376° C.), 1-tetracosene (bp 380° C. to 389° C.), trans-2-dodecene (mp −22° C., bp 211° C. to 217° C.), trans-6-tridecene (mp −11° C., bp 230° C. to 233° C.), cis-5-tridecene (mp −11° C. to −10° C., bp 230° C. to 233° C.), trans-2-tetradecene (mp 1° C. to 3° C., bp 250° C. to 253° C.), trans-9-octadecene (mp 23° C. to 25° C., bp 311° C. to 318° C.), cis-12-tetracosene (mp 96° C. to 97° C., bp 385° C. to 410° C.), or mixture(s) thereof. In some embodiments, the long-chain hydrocarbon solvent is 1-octadecene.

Aromatic hydrocarbons suitable for use as the long-chain hydrocarbon may include any of the above alkanes and alkenes where a hydrogen atom is substituted for a phenyl, naphthyl, anthracenyl, pyrrolyl, pyridyl, pyrazyl, pyrimidyl, imidazolyl, furanyl, or thiophenyl substituent.

Hydrocarbon mixtures suitable for use as the long-chain hydrocarbon may include mixtures with sufficiently high boiling points such that at least partial decomposition of the metal salts may occur upon heating below or at the boiling point of the mixture. Suitable mixtures may include: kerosene, lamp oil, gas oil, diesel, jet fuel, or marine fuel.

The long-chain organic acid may include any suitable organic acid with a long-chain, such as saturated carboxylic acids, mono unsaturated carboxylic acids, polyunsaturated carboxylic acids, saturated or unsaturated sulfonic acids, saturated or unsaturated sulfinic acids, saturated or unsaturated phosphonic acids, saturated or unsaturated phosphinic acids.

The long-chain organic acid may be selected from C12+ organic acids, such as C12 to C24, C14 to C24, C16 to C22, C16 to C20, or C16 to C18 organic acids. In some embodiments, the organic acid is a fatty acid, for example: caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, behenic acid, lignoceric acid, myristoleic acid, palmitoleic acid, sapienic acid, oleic acid, elaidic acid, vaccenic acid, petroselenic acid, linoleic acid, linoelaidic acid, α-linolenic acid, γ-linolenic acid, stearidonic acid, gondoic acid, paullinic acid, gondoic acid, gadoleic acid, arachidonic acid, eicosenoic acid, eicosapentaenoic acid, brassidic acid, erucic acid, adrenic acid, osbond acid, clupanodonic acid, docosahexaenoic acid, nervonic acid, colneleic acid, colnelenic acid, etheroleic acid, or etherolenic acid.

The long-chain organic acid may be selected from C12+ unsaturated acids, such as C12 to C24, C14 to C24, C16 to C22, C16 to C20, C16 to C18 unsaturated acids, such as myristoleic acid, palmitoleic acid, sapienic acid, vaccenic acid, petroselenic acid, oleic acid, elaidic acid, paullinic acid, gondoic acid, gadoleic acid, eicosenoic acid, brassidic acid, erucic acid, nervonic acid.

The long-chain organic acid may be selected from myristoleic acid, palmitoleic acid, cis-vaccenic acid, paullinic acid, oleic acid, gondoic acid, or gadoleic acid. In some embodiments, the long-chain organic acid is oleic acid.

The long-chain organic acids used to prepare the metal salts may be similar in chain length to the long-chain hydrocarbon solvent, such as where the long-chain organic acid and the long-chain hydrocarbon do not differ in numbers of carbon atoms by more than 4, such as 3 or less, or 2 or less. For example, if metal oleate salts are used, then suitable long-chain hydrocarbon solvents may include: 1-heptadecene, 1-octadecene, 1nonadecene, trans-2-octadecene, cis-9-octadecene or mixture(s) thereof.

Metal salts of the long-chain organic acid include the salt of (i) at least one metal selected from groups 1, 2, 3, 4, 5, 6, 11, 12, 13, 14, and 15, Mn, Fe, Co, Ni, or W, and combinations thereof; and (ii) a long-chain organic acid. As salts, the metals may be in a 2+, 3+, 4+, or 5+ oxidation state forming Metal(II), Metal(III), Metal(IV), and Metal(V) complexes with the long-chain organic acid. If an oxidation state is not specified the metal salt may include Metal(II), Metal(III), Metal(IV), and Metal(V) complexes.

The metal salts of long-chain organic acids may be M1 metal salts including the salt of an M1 metal and a long-chain organic acid. The metal salts of long-chain organic acids may be M2 metal salts including the salt of an M2 metal and a long-chain organic acid. The metal salts of long-chain organic acids may be M3 metal salts including the salt of an M3 metal and a long-chain organic acid.

In at least one embodiment, the M1 metal salt is selected from cobalt myristoleate, cobalt palmitoleate, cobalt cis-vaccenate, cobalt paullinate, cobalt oleate, cobalt gondoate, cobalt gadoleate, iron myristoleate, iron palmitoleate, iron cis-vaccenate, iron paullinate, iron oleate, iron gondoate, iron gadoleate, manganese myristoleate, manganese palmitoleate, manganese cis-vaccenate, manganese paullinate, manganese oleate, manganese gondoate, or manganese gadoleate.

In at least one embodiment, the M2 metal salt is selected from nickel myristoleate, nickel palmitoleate, nickel cis-vaccenate, nickel paullinate, nickel oleate, nickel gondoate, nickel gadoleate, zinc myristoleate, zinc palmitoleate, zinc cis-vaccenate, zinc paullinate, zinc oleate, zinc gondoate, zinc gadoleate, copper myristoleate, copper palmitoleate, copper cis-vaccenate, copper paullinate, copper oleate, copper gondoate, copper gadoleate, molybdenum myristoleate, molybdenum palmitoleate, molybdenum cis-vaccenate, molybdenum paullinate, molybdenum oleate, molybdenum gondoate, molybdenum gadoleate, tungsten myristoleate, tungsten palmitoleate, tungsten cis-vaccenate, tungsten paullinate, tungsten oleate, tungsten gondoate, tungsten gadoleate, silver myristoleate, silver palmitoleate, silver cis-vaccenate, silver paullinate, silver oleate, silver gondoate, or silver gadoleate.

In at least one embodiment, the M3 metal salt is selected from gallium myristoleate, gallium palmitoleate, gallium cis-vaccenate, gallium paullinate, gallium oleate, gallium gondoate, gallium gadoleate, indium myristoleate, indium palmitoleate, indium cis-vaccenate, indium paullinate, indium oleate, indium gondoate, indium gadoleate, scandium myristoleate, scandium palmitoleate, scandium cis-vaccenate, scandium paullinate, scandium oleate, scandium gondoate, scandium gadoleate, yttrium myristoleate, yttrium palmitoleate, yttrium cis-vaccenate, yttrium paullinate, yttrium oleate, yttrium gondoate, yttrium gadoleate, lanthanum myristoleate, lanthanum palmitoleate, lanthanum cis-vaccenate, lanthanum paullinate, lanthanum oleate, lanthanum gondoate, lanthanum gadoleate, cerium myristoleate, cerium palmitoleate, cerium cis-vaccenate, cerium paullinate, cerium oleate, cerium gondoate, cerium gadoleate, praseodymium myristoleate, praseodymium palmitoleate, praseodymium cis-vaccenate, praseodymium paullinate, praseodymium oleate, praseodymium gondoate, praseodymium gadoleate, neodymium myristoleate, neodymium palmitoleate, neodymium cis-vaccenate, neodymium paullinate, neodymium oleate, neodymium gondoate, neodymium gadoleate, gadolinium myristoleate, gadolinium palmitoleate, gadolinium cis-vaccenate, gadolinium paullinate, gadolinium oleate, gadolinium gondoate, gadolinium gadoleate, dysprosium myristoleate, dysprosium palmitoleate, dysprosium cis-vaccenate, dysprosium paullinate, dysprosium oleate, dysprosium gondoate, dysprosium gadoleate, holmium myristoleate, holmium palmitoleate, holmium cis-vaccenate, holmium paullinate, holmium oleate, holmium gondoate, holmium gadoleate, erbium myristoleate, erbium palmitoleate, erbium cis-vaccenate, erbium paullinate, erbium oleate, erbium gondoate, or erbium gadoleate.

The first dispersion system may also be formed by heating a mixture of a long-chain organic acid, a hydrocarbon solvent, and one or more metal salts of one or more second organic acids; and heating that mixture to T1. T1 may be a temperature at or higher than the lower of (i) the boiling point of the second organic acid or (ii) the decomposition temperature of the second organic acid. In some embodiments, the boiling point of the second organic acid is lower than T1. T1 may include temperatures from 50° C. to 350° C., such as 70° C. to 200° C., or 70° C. to 150° C. Heating at T1 may last from 10 min to 100 hours, such as from 10 min to 10 hours, 10 minutes to 5 hours, 10 minutes to 3 hours, or 10 minutes to 2 hours.

The second organic acid may include organic acids with a molecular weight lower than the molecular weight of the long-chain organic acids such as C8-organic acids, C1 to C7, C1 to C5, or C2 to C4 organic acids. Furthermore, the second organic acid may be more volatile than the long-chain organic acids. Some examples of suitable second acids are formic acid (bp 101° C.), acetic acid (bp 118° C.), propionic acid (bp 141° C.), butyric acid (bp 164° C.), lactic acid (bp 122° C.), citric acid (310° C.), ascorbic acid (decomp 190° C.), benzoic acid (249° C.), phenol (182° C.), acetylacetone (bp 140° C.), and acetoacetic acid (decomposition 80° C. to 90° C.). The second organic acid metal salts may include, for example, metal acetate, metal propionate, metal butyrate, metal lactate, metal acetylacetonate, or metal acetylacetate. Without being limited by theory, second organic acid disposed on the metal may be released from the metal by exchange with the long-chain organic acid and the second organic acid may be removed under decreased pressure or flow of inert gas. The greater volatility of the second organic acid may allow for efficient exchange as the second organic acid is removed from solution. Removal of the second organic acid may also allow for formation of the first dispersion system in a single reaction vessel and may further allow for direct use in nanoparticle formation in the same reaction vessel.

In some embodiments, the long-chain organic solvent and the long-chain organic acid are mixed prior to addition of metals, sulfur, organosulfur, or organophosphorus forming a liquid pre-mixture. To the liquid pre-mixture may be added one or more metal salts of one or more second organic acids, and optionally elemental sulfur, organosulfur, organophosphorus, or combinations thereof.

The optional sulfur or organic sulfur compounds may include elemental sulfur, alkyl thiols, aromatic thiols, dialkyl thioethers, diaryl thioether, alkyl disulfides, aryldisulfides, or mixture(s) thereof, such as 1-dodecanethiol (bp 266° C. to 283° C.), 1-tridecanethiol (bp 291° C.), 1-tetradecanethiol (bp 310° C.), 1-pentadecanethiol (bp 325° C.), 1-hexadecanethiol (bp 343° C. to 352° C.), 1-heptadecanethiol (bp 348° C.), 1-octadecanethiol (bp 355° C. to 362° C.), 1-icosanethiol (mp bp 383° C.), 1-docosanethiol (bp 404° C.), 1-tetracosanethiol (bp 423° C.), decyl sulfide (bp 217° C. to 218° C.), dodecyl sulfide (bp 260° C. to 263° C.), thiophenol (bp 169° C.), diphenyl sulfide (bp 296° C.), diphenyl disulfide (bp 310° C.), or mixture(s) thereof. The sulfur or organic sulfur compounds may be soluble in the long-chain organic solvent. The amount of sulfur or organic sulfur included in the first dispersion system is set by the mole ratio to the metal(s) in the first dispersion system.

The optional organophosphorus compounds may include alkylphosphines, dialkyl phosphines, trialkylphosphines, alkylphosphineoxides, dialkyphosphineoxides, trialkylphosphineoxides, tetraalkylphosphonium salts, and mixture(s) thereof. For example, suitable organophosphorus compound include tributylphosphine (bp 240° C.), trioctylphosphine (bp 284° C. to 291° C.), triphenylphosphine (bp 377° C.), tripentylphosphine (bp 310° C.), trihexylphosphine (bp 352° C.), diphneylphsophine (bp 280° C.), or mixture(s) thereof. The organic phosphorus compounds may be soluble in the long-chain organic solvent. The amount of organic phosphorus included in the first dispersion system is set by the mole ratio to the metal(s) in the first dispersion system.

The first dispersion system may be substantially free of surfactants other than salts of the long-chain organic acid. Alternatively, the first dispersion system optionally includes surfactant(s) other than the salts of the long-chain organic acid.

The processes of producing nanoparticle compositions of this disclosure may include heating the first dispersion system to a second temperature (T2), where T2 is greater than T1 and no higher than the boiling point of the long-chain hydrocarbon solvent. T2 can promote at least a portion of the first dispersion system to decompose and form a second dispersion system including nanoparticles described in this disclosure dispersed in the long-chain hydrocarbon solvent.

The second temperature may include temperatures from T2a to T2b, where T2a and T2b can be, independently, e.g., 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450° C., as long as T2a<T2b. In some embodiments, T2a is 210° C. or greater, such as where T2a=210 and T1b=450; or where T1a=250 and T1b=350.

The M1 metal salt(s), M2 metal salt(s) (if any), and M3 metal salt(s) (if any) can decompose at the second temperature to form the kernels. The kernels may be solid particles including the metal and oxygen atoms. The long-chain organic acids or a portion thereof may partly remain attached to the kernel's surface. Without being limited by theory, oxygen atoms from the long-chain organic acids may be included in the kernel as a portion of the oxygen atoms. Such partial attachments may be sufficient to withstand washing, centrifuging, and handling of the nanoparticles. Therefore, the nanoparticle composition may include kernels with long-chain hydrocarbyls attached to the surface of the kernels. Without being limited by theory, the long-chain hydrocarbyls attached to the kernel may allow for uniform dispersion in the second dispersion system and complete colloidal dissolution in hydrophobic solvents.

Furthermore, some portion of the long-chain organic acid salt may decompose to form an unsaturated compound (e.g. long-chain olefins) becoming a portion of the second dispersion system. The unsaturated compound may be identical to the long-chain hydrocarbon solvent if the solvent chosen is an alpha-olefin one carbon length shorter than the long-chain organic acid.

The decomposition of the metal salts forms kernels where two or three dimensions are from 4 nm to 100 nm in length, such as from 4 nm to 20 nm in length. The kernels can have a size distribution of 30% or less, 20% or less, 10% or less, or 5% or less, such as from 1% to 30%, from 5% to 20%, or from 5% to 10%. The size and size distribution are determined by TEM and SAXS.

The nanoparticle production processes may take place in one or more reaction vessels under an inert atmosphere. The processes may include separating the nanoparticle composition from the long-chain hydrocarbon solvent. A suitable method of separating the nanoparticles from the long-chain hydrocarbon solvent may include addition of a counter-solvent causing precipitation of the nanoparticles. Suitable counter solvents may include C1-C8 alcohols, such as C1-C6, C2-C4, or 1-butanol. Without being limited by theory, the increased polarity of the solution may cause the nanoparticles to precipitate out of solution where the counter solvent dissolves in the long-chain hydrocarbon solvent and long-chain organic acid mixture. Contaminants including unreacted metal salts, organic acids and corresponding salts may remain in the mixture of long-chain hydrocarbon solvent and counter-solvent and be removed in the process. The mixture of solvents and contaminants may be removed by centrifugation and decantation or filtration.

The nanoparticle production processes may also include further purification of the nanoparticles by a cleaning process. The cleaning may include (i) dispersing the nanoparticles in a hydrophobic solvent such as benzene, pentane, toluene, hexanes, or xylenes; (ii) adding a counter solvent to precipitate the nanoparticles; and (iii) collecting the precipitate by centrifugation or filtration. Cleaning, including steps (i) through (iii), may be repeated to further purify the nanoparticles.

### Catalyst Compositions

Purified and/or unpurified nanoparticles may be dispersed in hydrophobic solvents to form a nanoparticle dispersion, which may or may not be the same as the second dispersion system. Suitable hydrocarbon solvents for forming a nanoparticle dispersion may include benzene, pentane, toluene, hexanes, or xylenes. The nanoparticles may also be dispersed on a solid support by contacting the nanoparticle dispersion with the support. Suitable methods for contacting the nanoparticle dispersion with a solid support include: wet deposition, wet impregnation, or incipient wetness impregnation of the solid support. If the support is a large (greater than 100 nm) flat surface the nanoparticles may self-assemble into a monolayer on the support.

The catalyst composition of this disclosure can include a support material (which may be called a carrier or a binder), at any suitable quantity, e.g., ≥20, ≥30, ≥40, ≥50, ≥60, ≥70, ≥80, ≥90, or even ≥95 wt %, based on the total weight of the catalyst composition. In catalyst compositions, the nanoparticles can be suitably disposed on the internal or external surfaces of the support material. Support materials may include porous materials that provide mechanical strength and a high surface area. Non-limiting examples of suitable support materials can include oxides (e.g. silica, alumina, titania, zirconia, or mixture(s) thereof), treated oxides (e.g. sulfated), crystalline microporous materials (e.g. zeolites), non-crystalline microporous materials, cationic clays or anionic clays (e.g. saponite, bentonite, kaoline, sepiolite, or hydrotalcite), carbonaceous materials, or combination(s) and mixture(s) thereof. Deposition of the nanoparticles on a support can be effected by, e.g., incipient impregnation. A support material can be sometimes called a binder in a catalyst composition.

The supported nanoparticle composition of this disclosure may optionally include a solid diluent material. A solid diluent material is a solid material used to decrease nanoparticle to solid ratio and may be the same as the support material or selected from suitable support materials described above.

The nanoparticles can be combined with a support material, a promoter, or a solid diluent material, to form a catalyst composition. The combination of the support material and the nanoparticles can be processed in any suitable catalyst forming processes, including but not limited to grinding, milling, sifting, washing, drying, calcination, and the like. Drying or calcining the nanoparticles, optional promoter, and optional solid diluent material, on a support produces a catalyst composition. Drying and Calcining may take place at a third temperature (T3). The third temperature may include temperatures from T3a to T3b, where T3a and T3b can be, independently, e.g., 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650° C., as long as T2a<T2b. In some embodiments, T2a is 500° C. or greater, such as where T2a=500° C. and T1b=650° C.; or where T1a=550° C. and T1b=600° C. The catalyst composition may be then disposed in an intended reactor to perform its intended function, such as a syngas converting reactor in a syngas converting process.

It is also contemplated that the nanoparticles may be combined or formed with a precursor of a support material to obtain a supported catalyst composition precursor mixture. Suitable precursors of various support materials can include, e.g., alkali metal aluminates, water glass, a mixture of alkali metal aluminates and water glass, a mixture of sources of a di-, tri-, and/or tetravalent metal, such as a mixture of water-soluble salts of magnesium, aluminum, and/or silicon, chlorohydrol, aluminum sulfate, or mixture(s) thereof. The support/catalytic component precursor mixture is subsequently subject to drying and calcining, resulting in the formation of the catalytic component and the support material substantially in the same step.

A promoter may be added to a catalyst composition forming a catalyst precursor composition. The catalyst precursor may be dried and/or calcined to form a catalyst composition including a promoter. Promoters may include sulfur, phosphorus, or salts of elements selected from groups 1, 7, 11, or 12 of the periodic table, such as Li, Na, K, Rb, Cs, Re, Cu, Zn, Ag, and mixture(s) thereof. Typically, sulfide or sulfate salts are used. For example, a promoter may be added to a supported nanoparticle composition or a catalyst composition as part of a solution, the solvent can then be removed via evaporation (e.g. an aqueous solution where the water is later removed).

Without being bound by a particular theory, it is believed that the metal oxide(s), and possibly the elemental phases of M1 in the kernel provide the catalytic activity for chemical conversion processes such as a Fischer-Tropsch synthesis. One or more of M2 and/or M3 can provide direct catalytic function as well. In addition, one or more of M2 and/or M3 can perform the function of a “promoter” in the catalytic composition. Furthermore, sulfur and or phosphorus, if present, can perform the function of a promoter in the catalytic composition as well. Promoters typically improve one or more performance properties of a catalyst. Example properties of catalytic performance enhanced by inclusion of a promoter in a catalyst over the catalyst composition without a promoter, may include selectivity, activity, stability, lifetime, regenerability, reducibility, and resistance to potential poisoning by impurities such as sulfur, nitrogen, and oxygen.

It may be advantageous for the nanoparticles to be dispersed in the catalytic composition. The nanoparticles can be substantially homogeneously distributed in the catalytic composition, resulting in a highly dispersed distribution, which can contribute to a high catalytic activity of the catalytic composition.

The synthesis methods disclosed may produce crystalline kernels with uniform particle shape and size. The kernels include metal oxide(s) that may be uniformly distributed throughout the kernel, which may improve catalysis when the kernel is included in a catalyst composition. The kernel may be part of a nanoparticle which may include long-chain hydrocarbons disposed on the kernel. The nanoparticles may be formed in a single reaction vessel from readily available precursors. The nanoparticle may be dispersed in hydrophobic solvents, and thereby dispersed on a solid support. The nanoparticles dispersed on solid support may together be dried and or calcined to form a catalyst composition.

### Processes for Converting Syngas

The nanoparticle compositions and/or the catalyst compositions of this disclosure may be used in any process where the relevant metal(s) and/or the metal oxide(s) can perform a catalytic function. The nanoparticle compositions and/or the catalyst compositions of this disclosure can be particularly advantageously used in processes for converting syngas into various products such as alcohols and olefins, particularly C1-C5 alcohols, such as C1-C4 alcohols, and C2-C5 olefins (particularly C2-C4 olefins), such as the Fischer-Tropsch processes. The Fischer-Tropsch process is a collection of chemical reactions that converts a mixture of carbon monoxide and hydrogen into hydrocarbons and/or alcohols. The products formed are the “conversion product mixture.” These reactions occur in the presence of metal catalysts, typically at temperatures of 100 to 500° C. (212 to 932° F.) and pressures of one to several tens of atmospheres.

The term “syngas” as used herein relates to a gaseous mixture consisting essentially of hydrogen (H₂) and carbon monoxide (CO). The syngas, which is used as a feed stream, may include up to 10 mol % of other components such as CO₂ and lower hydrocarbons (lower HC), depending on the source and the intended conversion processes. Said other components may be side-products or unconverted products obtained in the process used for producing the syngas. The syngas may contain such a low amount of molecular oxygen (O₂) so that the quantity of O₂ present does not interfere with the Fischer-Tropsch synthesis reactions and/or other conversion reactions. For example, the syngas may include not more than 1 mol % O₂, not more than 0.5 mol % O₂, or not more than 0.4 mol % O₂. The syngas may have a hydrogen (H₂) to carbon monoxide (CO) molar ratio of from 1:3 to 3:1. The partial pressures of H₂ and CO may be adjusted by introduction of inert gas to the reaction mixture.

Syngas can be formed by reacting steam and/or oxygen with a carbonaceous material, for example, natural gas, coal, biomass, or a hydrocarbon feedstock through a reforming process in a syngas reformer. The reforming process can be based on any suitable reforming process, such as Steam Methane Reforming, Auto Thermal Reforming, or Partial Oxidation, Adiabatic Pre Reforming, or Gas Heated Reforming, or a combination thereof. Example steam and oxygen reforming processes are detailed in U.S. Pat. No. 7,485,767.

The syngas formed from steam or oxygen reforming includes hydrogen and one or more carbon oxides (CO and CO₂). The hydrogen to carbon oxide ratio of the syngas produced will vary depending on the reforming conditions used. The syngas reformer product(s) should contain H₂, CO and CO₂ in amounts and ratios which render the resulting syngas blend suitable for subsequent processing into either oxygenates comprising methanol/dimethyl ether or in Fischer-Tropsch synthesis.

The syngas from reforming to be used in Fischer-Tropsch synthesis may have a molar ratio of H₂ to CO, unrelated to the quantity of CO₂, of 1.9 or greater, such as from 2.0 to 2.8, or from 2.1 to 2.6. On a water-free basis, the CO₂ content of the syngas may be 10 mol % or less, such as 5.5 mol % or less, or from 2 mol % to 5 mol %, or from 2.5 mol % to 4.5 mol %.

It is possible to alter the ratio of components within the syngas and the absolute CO₂ content of the syngas by removing, and optionally recycling, some of the CO₂ from the syngas produced in one or more reforming processes. Several commercial technologies are available (e.g. acid gas removal towers) to recover and recycle CO₂ from syngas as produced in the reforming process. In at least one embodiment, CO₂ can be recovered from the syngas effluent from a steam reforming unit, and the recovered CO₂ can be recycled to a syngas reformer.

Suitable Fischer-Tropsch catalysis procedures may be found in: U.S. Pat. Nos. 7,485,767; 6,211,255; and 6,476,085; the relevant portions of their contents being incorporated herein by reference. A nanoparticle composition and/or a catalyst composition may be contained in a conversion reactor (a reactor for the conversion of syngas), such as a fixed bed reactor, a fluidized bed reactor, or any other suitable reactor. The conversion conditions may include contacting a catalyst composition and/or a nanoparticle composition with syngas, to provide a reaction mixture, at a pressure of 1 bar to 50 bar, at a temperature of 150° C. to 450° C., and/or a gas hourly space velocity of 1000 h⁻¹ to 10,000 h⁻ for a reaction period.

The conversion conditions may include a wide range of temperatures. In at least one embodiment, the reaction temperature may be from 100° C. to 450° C., such as from 150° C. to 350° C., such as from 200° C. to 300° C. For certain catalyst compositions or nanoparticle compositions, lower temperature ranges might be preferred, but if the composition includes cobalt metal, higher temperatures are tolerated. For example, a catalyst composition including cobalt metal may be used at reaction temperatures of 250° C. or greater, such as from 250° C. to 350° C., or from 250° C. to 300° C.

The conversion conditions may include a wide range of reaction pressures. In at least one embodiment, the absolute reaction pressure ranges from p1 to p2 kilopascal (“kPa”), wherein p1 and p2 can be, independently, e.g., 100, 150, 200, 250, 300, 350, 400, 450, 500, 600, 700, 800, 900, 1000, 1500, 2000, 2500, 3000, 3500, 4000, 4500, or 5,000, as long as p1<p2.

Gas hourly space velocities used for converting the syngas to olefins and/or alcohols can vary depending upon the type of reactor that is used. In one embodiment, gas hourly space velocity of the flow of gas through the catalyst bed is from 100 hr⁻ to 50,000 hr⁻, such as from 500 hr⁻ to 25,000 hr⁻, from 1000 hr⁻ to 20,000 hr⁻, or from 100 hr⁻ to 10,000 hr⁻.

Conversion conditions may have an effect on the catalyst performance. For example, selectivity on a carbon basis is a function of the probability of chain growth. Factors affecting chain growth include reaction temperatures, the gas composition and the partial pressures of the various gases in contact with the catalyst composition or the nanoparticle composition. Altering these factors may lead to a high degree of flexibility in obtaining a type of product in a certain carbon range. Without being limited by theory, an increase in operating temperature shifts the selectivity to lower carbon number products. Desorption of growing surface species is one of the main chain termination steps and since desorption is an endothermic process so a higher temperature should increase the rate of desorption which will result in a shift to lower molecular mass products. Similarly, the higher the CO partial pressure, the more catalyst surface that is covered by adsorbed monomers. The lower the coverage by partially hydrogenated CO monomers, the higher the probability of chain growth. Accordingly, it is probable that the two key steps leading to chain termination are desorption of the chains yielding alkenes and hydrogenation of the chains to yield alkanes.

### EXAMPLES

### Example 1a. Preparation of MnO Nanoparticles

A reaction solution was prepared by dissolving manganese acetate (Mn(CH₃COO)₂) in a mixture of oleic acid (OLAC) and 1-octadecene. The reaction solution had a molar ratio of 2.5 mol OLAC:mol Mn and a manganese concentration of 0.05 mmol Mn/mL of 1-octadecene. The reaction solution was heated to a temperature of 95° C. under vacuum (1 Torr absolute) and held at 95° C. for 30 minutes. The mixture was then heated under an inert atmosphere of nitrogen at a rate of 10° C./min to reflux (320° C.). The reaction mixture was held at 320° C. for 15 min. The reaction mixture was cooled under an inert atmosphere using a flow of RT air to cool the exterior of the reaction vessel. The nanoparticles were collected and purified via repeated washing and decanting/centrifugation steps using hexane as a hydrophobic solvent, and isopropanol as a counter solvent. The purified nanoparticles were dispersed in toluene. TEM imagery shows that the nanoparticles are roughly spherical in shape, have an average diameter of 14.3 nanometers and a size distribution of 9%.

### Example 1b. Preparation of MnO Nanoparticles

A reaction solution was prepared by dissolving manganese acetate (Mn(CH₃COO)₂) in a mixture of oleic acid (OLAC and 1-octadecene. The reaction solution had a molar ratio of 2.5 mol OLAC: mol Mn and a manganese concentration of 0.16 mmol Mn/mL of 1-octadecene. The reaction solution was heated to a temperature of 95° C. under vacuum (1 Torr absolute) and held at 95° C. for 60 minutes. The mixture was then heated under an inert atmosphere of nitrogen at a rate of 10° C./min to reflux (320° C.). The reaction mixture was held at 320° C. for 15 min. The reaction mixture was cooled under an inert atmosphere using a flow of RT air to cool the exterior of the reaction vessel. The nanoparticles were collected and purified via repeated washing and decanting/centrifugation steps using hexane as a hydrophobic solvent, and isopropanol as a counter solvent. The purified nanoparticles were dispersed in toluene. TEM imagery shows that the nanoparticles are roughly spherical in shape, have an average diameter of 5.7 nanometers and a size distribution of 9%.

The comparison of examples 1a and 1b demonstrates that increasing the metal (in this case manganese) concentration decreases the average size of the nanoparticles without much effect on the particle size distribution.

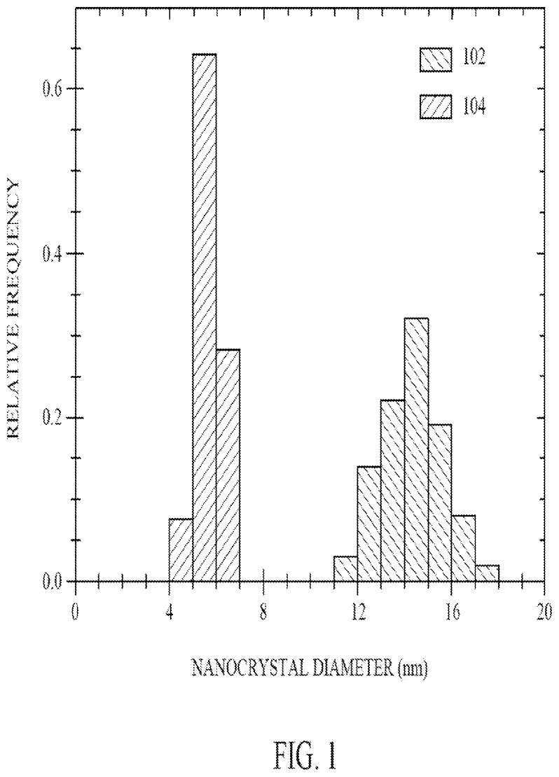

FIG. 1 is a graph showing particle size distributions of MnO nanoparticles synthesized with concentrations of 0.05 mmol Mn/mL of 1-octadecene and 0.16 mmol Mn/mL of 1-octadecene, according to example 1a and 1b. As shown in FIG. 1, bars 102 shows the relative frequency of nanoparticles made according to example 1a, with an average particle size of 14.3 nanometers and a size distribution of 9%. Bars 104 shows the relative frequency of nanoparticles made according to example 1b, with an average particle size of 5.7 nanometers and a size distribution of 9%.

### Example 2a. Preparation of MnCoOₓ Nanoparticles

A reaction solution was prepared by dissolving manganese (II) acetylacetonate (Mn(CH₃COCHCOCH₂)₂) and Cobalt (II) acetate tetrahydrate (Co(CH₃COO)₂.4H₂O) in a mixture of oleic acid (OLAC) and 1-octadecene. The reaction solution had a molar ratio of 4.5 mol OLAC:mol metal and a combined metal concentration of 0.16 mmol Mn/mL of 1-octadecene. The reaction solution was heated to a temperature of 130° C. under flow if nitrogen and held at 130° C. for 90 minutes. The mixture was then heated under an inert atmosphere of nitrogen at a rate of 10° C./min to reflux (320° C.). The reaction mixture was held at 315° C. for 20 min. The reaction mixture was cooled under an inert atmosphere using a flow of RT air to cool the exterior of the reaction vessel. The nanoparticles were collected and purified via repeated washing and decanting/centrifugation steps using hexane as a hydrophobic solvent, and isopropanol as a counter solvent. The purified nanoparticles were dispersed in toluene. TEM imagery shows that the nanoparticles are roughly spherical in shape, have an average diameter of 13 nanometers and a size distribution of 12%.

### Example 2b. Preparation of MnCoOₓ Nanoparticles

A reaction solution was prepared by dissolving manganese (II) acetylacetonate (Mn(CH₃COCHCOCH₂)₂) and Cobalt (II) acetate tetrahydrate (Co(CH₃COO)₂.4H₂O) in a mixture of oleic acid (OLAC) and 1-octadecene. The reaction solution had a molar ratio of 4.5 mol OLAC:mol metal and a combined metal concentration of 0.04 mmol Mn/mL of 1-octadecene. The reaction solution was heated to a temperature of 95° C. under vacuum (1 mmHg absolute) and held at 95° C. for 30 minutes. The mixture was then heated under an inert atmosphere of nitrogen at a rate of 10° C./min to reflux (320° C.). The reaction mixture was held at 320° C. for 10 min. The reaction mixture was cooled under an inert atmosphere using a flow of RT air to cool the exterior of the reaction vessel. The nanoparticles were collected and purified via repeated washing and decanting/centrifugation steps using hexane as a hydrophobic solvent, and isopropanol as a counter solvent. The purified nanoparticles were dispersed in toluene. TEM imagery shows that the nanoparticles are roughly spherical in shape, have an average diameter of 8.1 nanometers and a size distribution of 14%.

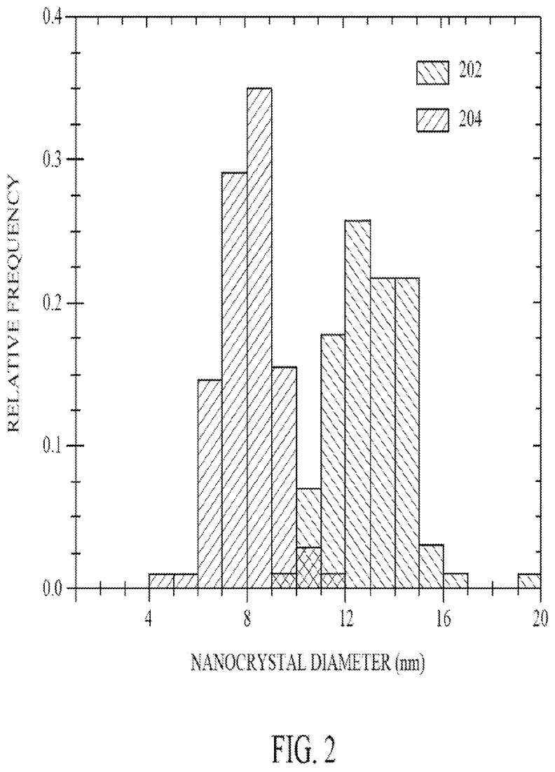

FIG. 2 is a graph showing particle size distributions of MnCoOₓ nanoparticles synthesized where one was first heated under an atmosphere of nitrogen (example 2a) and another was first heated under reduced pressure (Example 2b). As shown in FIG. 2, bar 202 shows the relative frequency of nanoparticles made according to example 2a, with an average particle size of 13 nanometers and a size distribution of 12%. Bar 204 shows the relative frequency of nanoparticles made according to example 2b, with an average particle size of 8.1 nanometers and a size distribution of 14%. Comparison of examples 2a and 2b suggests that the use of reduced pressure in the formation the first dispersion system can produce nanoparticles with a smaller average size and a narrower particle size distribution.

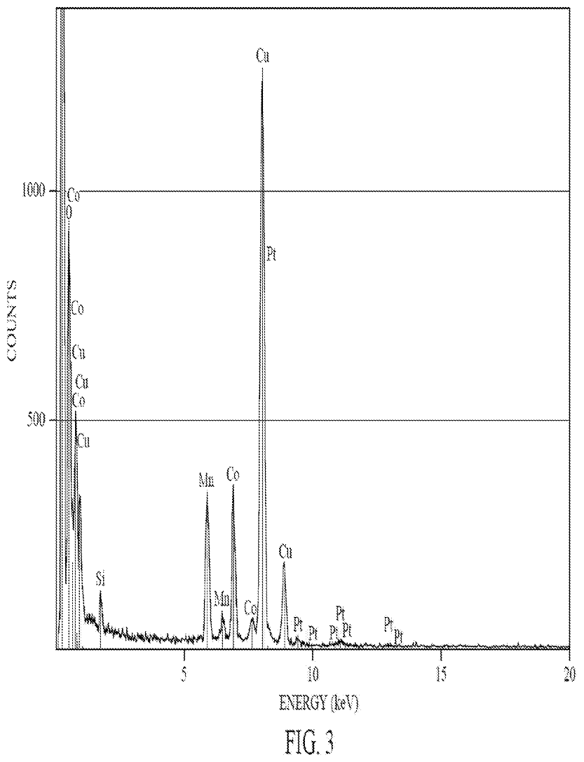

FIG. 3 is a graph showing an energy dispersive X-ray spectrum (EDX) of MnCoOₓ nanoparticles, prepared pursuant to the procedure of Example 2a. The EDX peaks confirm the elemental composition of the material.

### Example 3. Preparation of MnCoOx Rod-Shaped Nanoparticles

A reaction solution was prepared by dissolving manganese (II) acetylacetonate acetate (Mn(CH₃COCHCOCH₂)₂) and Cobalt (II) acetate tetrahydrate (Co(CH₃COO)₂.4H₂O) in a mixture of oleic acid (OLAC) and 1-octadecene. The reaction solution had a molar ratio of 4.5 mol OLAC: mol Metal (Mn+Co) and a combined metal concentration of 0.9 mmol Mn/mL of 1-octadecene. The reaction solution was heated to a temperature of 130° C. under flowing nitrogen and held at 130° C. for 60 minutes. The mixture was then heated under an inert atmosphere of nitrogen at a rate of 10° C./min to reflux (320° C.). The reaction mixture was held at 320° C. for 120 min. The reaction mixture was cooled under an inert atmosphere using a flow of RT air to cool the exterior of the reaction vessel. The nanoparticles were collected and purified via repeated washing and decanting/centrifugation steps using hexane as a hydrophobic solvent, and isopropanol as a counter solvent. The purified nanoparticles were dispersed in toluene. TEM images illustrated that the nanoparticles are rod-shaped, have an average length of 64.1 with a length distribution of 15% and an average width of 11.7 nanometers with a width distribution of 13%.

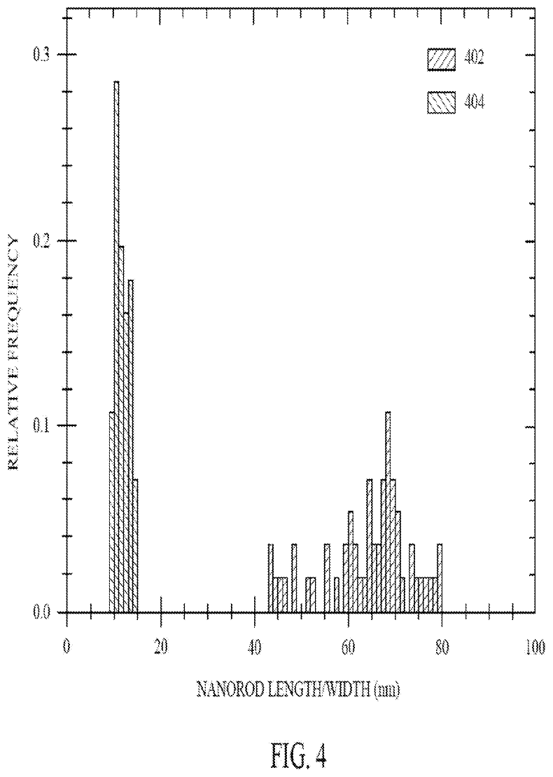

FIG. 4 is a graph showing length and width distributions of MnCoOx rod-shaped nanoparticles synthesized according to Example 3. As shown in FIG. 4, bars 402 shows the relative frequency of the length of rod-shaped nanoparticles made according to Example 3, with an average length of 64.1 nanometers and a length distribution of 15%. Bars 404 show the relative frequency of the width of rod-shaped nanoparticles made according to Example 3, with an average width of 11.7 nanometers and a width distribution of 13%. The narrow length and width distributions demonstrate a consistent formation of rod-shaped nanoparticles.

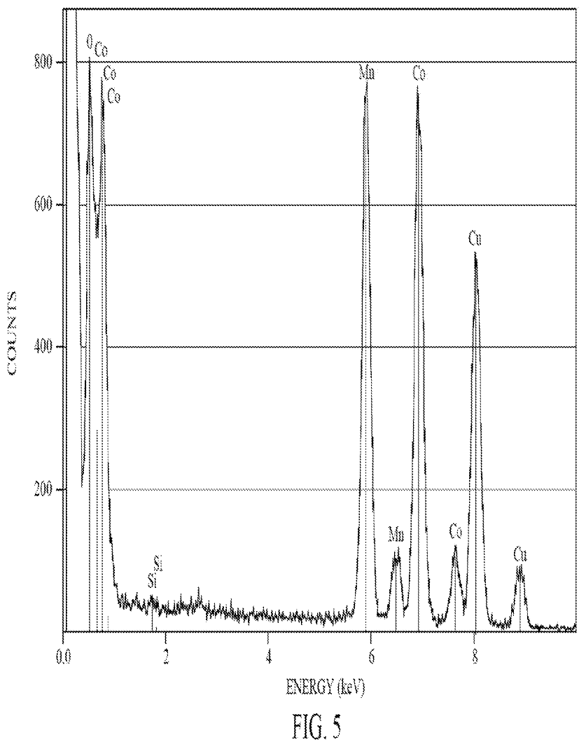

FIG. 5 is a graph showing an EDX of MnCoOₓ rod-shaped nanoparticles, prepared pursuant to the procedure of Example 3. The EDX peaks confirm the elemental composition of the material.

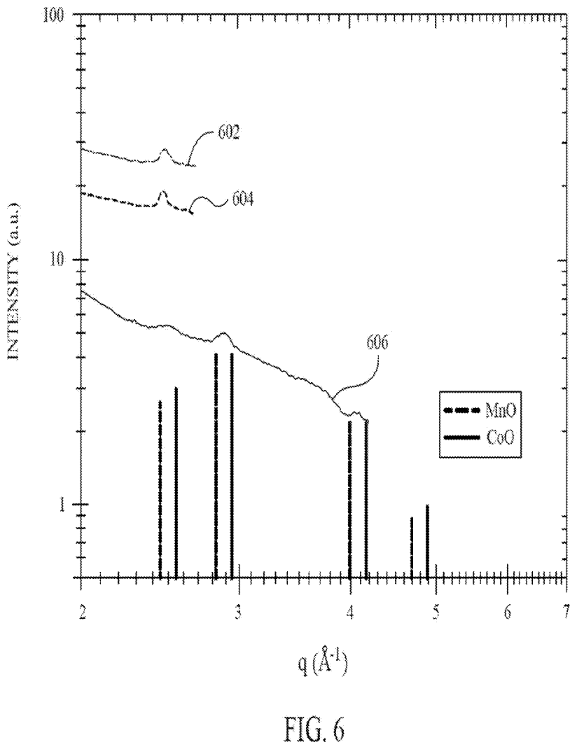

FIG. 6. is a graph showing Wide-Angle X-ray scattering (“WAXS”) of spherical MnCoOₓ nanoparticles, according to Example 2a and rod-shaped MnCoOₓ nanoparticles, according to Example 3, with reference peaks of MnO and CoO. Line 602 shows the WAXS intensity at q of MnCo₂Oₓ spherical nanoparticles, line 604 shows the WAXS intensity at q of MnCoOₓ rod-shaped nanoparticles, and line 606 shows the WAXS intensity at q of MnCoOₓ spherical nanoparticles. References are given for WAXS intensity of pure MnO and CoO particles. The WAXS data demonstrate that both the spherical and rod-shaped nanoparticles are highly crystalline (greater than 90%) and correspond to both MnO and CoO crystal structures.

Other non-limiting aspects and/or embodiments of the present disclosure can include:

A1. A composition including a plurality of nanoparticles, where each nanoparticle includes a kernel, the kernels include at least one metal element and oxygen, and the kernels have an average particle size from 4 to 100 nm, and a particle size distribution, expressed as a percentage of the standard deviation of the particle size relative to the average particle size, of no greater than 20%, as determined by small angle X-ray scattering (“SAXS”) and transmission electron microscopy (“TEM”) image analysis.

A2. The composition of embodiment A1, where the kernels include an oxide of the at least one metal element.

A3. The composition of embodiment A1 or A2, where the nanoparticles have an average particle size from 4 to 35 nm.

A4. The composition of any of embodiments A1 to A3, where the nanoparticles have a size distribution of no greater than 15%.

A5. The composition of any of embodiments A1 to A3, where the kernels include at least two metal elements.

A6. The composition of A5, where the at least two metal elements are uniformly distributed in the nanoparticles.

A7. The composition of any of embodiments A1 to A6, where the nanoparticles include a plurality of hydrophobic long-chain groups attached to the surface of the kernels.

A8. The composition of A7, where the long-chain groups include a C14-C24 hydrocarbyl group.

A9. The composition of any of embodiments A1 to A8, where the composition includes a solvent in which at least a portion of the nanoparticles are suspended.

A10. The composition of embodiment A8, where the solvent is hydrophobic.

A11. The composition of embodiment A9, where the solvent is selected from toluene, hexanes, chloroform, THF, cyclohexane, and combinations of two or more thereof.

A12. The composition of any of embodiments A1 to A7, where the nanoparticles form a self-assembled structure.

A13. The composition of any of embodiment A1 to A12, further including a solid support, where at least a portion of the nanoparticles are disposed on the surface of the solid support.

A14. The composition of any of embodiments A1 to A13, where the at least one metal is selected from Groups 1, 2, 3, 4, 5, 6, 11, 12, 13, 14, and 15 metals, Mn, Fe, Co, Ni, W, Mo, and combinations of two or more thereof.

A15. The composition of A14, where the at least one metal elements includes a metal element M1, an optional metal element M2, and optionally a third metal element M3, M1 is selected from Mn, Fe, Co, and combination of two or more thereof in any proportion, M2 is selected from Ni, Zn, Cu, Mo, W, Ag, and M3 is selected from the lanthanides, Y, Sc, alkaline metals, group 13, 14, and 15 elements, where the molar ratios of M2, M3, S, and P, if any, to M1 is r1, r2, r3, and r4, respectively, and 0≤r1≤2, 0≤r2≤2, 0≤r3<5, 0≤r4≤5.

A16. The composition of A15, where 0≤r1≤0.5, and 0≤r2≤0.5.

A17. The composition of A15, where 0.05≤r1≤0.5, and 0.005≤r2≤0.5.

A18. The composition of any of A1 to A18, where the kernels further include sulfur.

A19. The composition of A18, where the molar ratio of sulfur to M1 is r3, and 0<r3≤2.

A20. The composition of any of A1 to A19, where the kernels further include phosphorous.

A21. The composition of A20, where the molar ratio of phosphorous to M1 is r4, and 0<r4<2.

A22. The composition of any of A1 to A21, where the kernels are substantially spherical in shape.

A23. The composition of any of A1 to A21, where the kernels are rod-shaped.

A24. The composition of A23, where the kernels have an aspect ratio of from 1 to 10.

A25. The composition of A24, where the kernels have an aspect ratio of from 4 to 8.

B1. A process for making a composition including a plurality of nanoparticles, where the nanoparticles include an oxide of at least one metal element, and the process include:

(I) providing a first dispersion system at a first temperature, the first dispersion system including a salt of a long-chain organic acid of the at least one metal element, a long-chain hydrocarbon solvent, optionally a salt of a second organic acid of the at least one metal element, optionally sulfur or an organic sulfur compound soluble in the long-chain hydrocarbon solvent, and optionally an organic phosphorus compound soluble in the long-chain hydrocarbon solvent; and

heating the first dispersion system to a second temperature higher than the first temperature but no higher than the boiling point of the long-chain hydrocarbon solvent, where at least a portion of the salt of the long-chain organic acid and at least a portion of the salt of the second organic acid, if present, decomposes to form a second dispersion system including nanoparticles dispersed in the long-chain hydrocarbon solvent, and the nanoparticles include kernels, and the kernels include the at least one metal element, oxygen, optionally sulfur, and optionally phosphorous.

B2. The process of embodiment B1, where the nanoparticles further include long hydrocarbon chains attached to the surface of the kernels.

B3. The process of embodiment B1 or B2, where the nanoparticles are uniformly distributed in the second dispersion system.

B4. The process of any of embodiments B1 to B3, where the nanoparticles have an average particle size from 4 to 100 nm, and a particle size distribution of no greater than 20%, expressed as the percentage of the standard deviation of the particle size relative to the average particle size, as determined by small angle X-ray scattering (“SAXS”) and transmission electron microscopy (“TEM”) image analysis.

B4a. The process of embodiment B4, where the nanoparticles have an average particle size from 4 to 20 nm, as determined by SAXS and TEM image analysis.

B5. The process of any of embodiments B1 to B4a, where step (I) includes:

(Ia) providing a first liquid mixture of the long-chain organic acid, the long-chain hydrocarbon solvent, and the salt of the second organic acid;

(Ib) heating the second mixture to the first temperature to obtain the first dispersion system.

B5a. The process of embodiment B5, where steps (Ia), (Ib), and are all performed in the same vessel.

B5b. The process of B5, where in step (Ia), the first liquid mixture includes (i) elemental sulfur and/or an organic-sulfur compound soluble in the long-chain hydrocarbon solvent, and/or a phosphorous-containing organic compound soluble in the long-chain hydrocarbon solvent at the first temperature.

B5c. The process of any of B5 to B5a, where step (Ia) includes:

(Ia.1) mixing the long-chain organic acid with the long-chain hydrocarbon solvent to obtain a liquid pre-mixture;

(Ia.2) adding, to the liquid pre-mixture obtained in (Ia.1), (i) the salt of the second organic acid; and optionally elemental sulfur and/or an organic-sulfur compound soluble in the long-chain hydrocarbon solvent, and (iii) optionally a phosphorous-containing organic compound soluble in the long-chain hydrocarbon solvent at the first temperature.

B5d. The process of any of embodiments B1 to B5c, where the first dispersion system is substantially free of a surfactant other than the salt of the long-chain organic acid.

B6. The process of embodiment B5, where in step (Ib), the first mixture is heated to a temperature no lower than the boiling point of the second organic acid or the decomposition temperature of the second organic acid, whichever is lower.

B7. The process of embodiment B5 or B6, where the second organic acid has a boiling point lower than the first temperature.

B8. The process of embodiment B6, where the second organic acid is selected from: formic acid, acetic acid, citric acid, propionate acid, actylacetonic acid, ascorbic acid, benzylic acid, phenol, acetyl acetone, and the like.

B8a. The process of embodiment B8, where the second organic acid is acetic acid.

B9. The process of any of embodiments B5 to B8, where the second mixture is heated to a temperature from 70° C. to 150° C. in step (Ib).

B10. The process of embodiment B9, where the second mixture is heated to a temperature from 70° C. to 200° C. for a period oft minutes, where 10≤t≤120.

B11. The process of any of embodiments B1 to B6, where the second temperature is at least 210° C.

B12. The process of any of embodiments B1 to B11, where the second temperature is from 210° C. to 450° C.

B13. The process of any of embodiments B1 to B12, where the long-chain organic acid is selected from C14-C24 fatty acids and mixture(s) of two or more thereof, and the long-chain hydrocarbon solvent is selected from a C14-C24 hydrocarbons and mixture(s) of two or more thereof.

B14. The process of embodiment B13, where the long-chain organic acid is selected from C14-C24 mono-unsaturated fatty acids, and mixture(s) of two or more thereof, and/or the long-chain hydrocarbon solvent is selected from a C14-C24 unsaturated hydrocarbons and mixture(s) of two or more thereof.

B15. The process of embodiment B13 or B14, where the long-chain organic acid and the long-chain hydrocarbon solvent do not differ in number of average carbon atoms per molecule by more than 4.

B16. The process of ay of B1 to B13, where the long-chain organic acid is oleic acid, and the long-chain hydrocarbon solvent is 1-octadecene.

B16a. The process of any of embodiments B1 to B16, where step (I) and/or step are performed in the presence of an inert atmosphere.

B17. The process of any of embodiments B1 to B16, further including:

(III) separating the nanoparticles from the second dispersion system.

B18. The process of embodiment B18, further including:

(IV) cleaning the separated nanoparticles.

B19. The process of embodiment B17 or B18, further including: (V) dispersing the nanoparticles in a hydrophobic solvent.

B20. The process of any of embodiments B1 to B 20, further including:

(VI) dispersing the nanoparticles on the surface of a support.

B21. The process of any of embodiments B1 to B20, where the at least one metal element is selected from Mn, Fe, Co, Mo, W, the lanthanide series, the actinide series, the metals of Groups 1, 2, 3, 4, 5, 6, 11, 12, 13, 14, and 15, and mixture(s) and combinations of two or more thereof.

B22. The process of any of embodiments B1 to B21, where the at least one metal element comprises a combination of Co and Mn; Fe and Mn; or Cu, Fe, and Zn.

B23. The process of embodiment B22, where the at least one metal element comprises a promoter selected from sulfide or sulfate salts of Li, Na, K, Rb, Cs, Cu, Zn, or Ag.

B24. The process of any of embodiments B1 to B23, further including:

(VII) after step (V), drying and/or calcining the support to obtain a catalyst composition including the support and a catalytic component including the at least one metal, oxygen, optionally sulfur, and optionally phosphorous.

B25. The process of any of embodiments B1 to B24 wherein the at least one metal element is present in the long-chain hydrocarbon solvent at a concentration of ≥0.5 mmol/mL.

C1. A process for making a catalyst composition, the process including:

(A) providing the composition of any of embodiments A1 to A11;

(B) contacting the composition with a support to disperse the nanoparticles on the surface of the support; and

(C) drying and/or calcining the support after step (B) to obtain the catalyst composition including the support and a catalytic component on the surface of the support, the catalytic component including the at least one metal, oxygen, optionally sulfur, and optionally phosphorous.

C2. The process of C1, where step (A) is affected by any of the process of embodiments B1 to B19.

D1. A composition including a kernel including a metal oxide represented by Formula (F-1):

MₐM′_{b}Oₓ (F-1)

where:

M is a first metal selected from manganese, iron, or cobalt;

M′ is a second metal selected from transition metals and main group elements other than

the first metal;

a and x are greater than 0 to 1; and

b is from 0 to 1;

where:

the metal oxide has a particle size of from about 4 nm to about 20 nm; and

the metal oxide has a size distribution of about 20% or less.

D2. The composition of embodiment D1, where the first metal is manganese.

D3. The composition of any of embodiments D1 to D2, where the second metal is selected from zinc, copper, or tin.

D4. The composition of any of embodiments D1 to D3, where the ratio of a:b is from about 1:3 to about 2:1.

D6. The composition of any of embodiments D1 to D5, where one or more long-chain organic acids are disposed on the metal oxide.

D7. The composition of embodiment D6, where the one or more long-chain organic acids is oleic acid.

E1. A process of producing a nanoparticle including a kernel including a metal oxide represented by Formula (F-1):

MₐM′_{b}Oₓ (F-1)

where:

M is a first metal selected from manganese, iron, or cobalt;

M′ is a second metal selected from transition metals, and main group elements other than

the first metal;

a, and x are greater than 0 to 1; and

b is from 0 to 1;

where:

the kernel has a particle size of from about 4 nm to about 20 nm; and

the kernel has a size distribution of about 20% or less.

the process including:

introducing at least one metal salt of a second organic acid, a long-chain organic acid, and a long-chain hydrophobic solvent to a reaction vessel at a first temperature to form a reaction mixture; and

applying heat to the reaction mixture until it reaches a second temperature to form a product mixture.

E2. The process of embodiment E2, where the long-chain hydrophobic solvent has a boiling point of about 200° C. or higher.

E3. The process of any of embodiments E1 to E2, where the first temperature is from 70° C. to 150° C. and further including maintaining the reaction mixture under an inert atmosphere at the first temperature from 30 minutes to 3 hours.

E4. The process of any of embodiments E1 to E2, where the first temperature is from 70° C. to about 150° C. and further including maintaining the reaction mixture under pressure reduced below atmospheric pressure at the first temperature for from 30 minutes to 3 hours.

E5. The process of any of embodiments E1 to E4, further including cooling the product mixture to form a cooled product mixture.

E6. The process of embodiment E5, further including precipitating the cooled product mixture with a counter solvent selected from ethanol or isopropanol to form a precipitated composition.

E7. The process of embodiment E6, further including:

centrifuging the precipitated composition to form a supernatant and a pellet; and

decanting the supernatant.

E8. The process of embodiment E7, further including washing the pellet, where washing includes:

dispersing the pellet in a hydrophobic solvent to form a solution;

precipitating a purified precipitated composition from the solution using a counter solvent;

centrifuging the purified precipitated composition to form a supernatant; and decanting the supernatant.

E9. The process of any of embodiments E1 to E8, where the at least one organic metal salt includes a mixture of organic salts of the first metal and the second metal.

E10. The process of any of embodiments E1 to E9, where the ratio a:b is from about 1:3 to about 2:1.

E11. The process of any of embodiments E1 to E10, where a molar ratio of metal salt to long-chain organic acid of the reaction mixture is from about 1:2 to about 1:8.

E12. The process of any of embodiments E1 to E11, where the hydrophobic solvent is selected from C14+ straight-chain alkanes or alkenes.

E13. The process of any of embodiments E1 to E12, where the hydrophobic solvent is 1-octadecene.

E14. The process of any of embodiments E1 to E13, where the long-chain organic acid is oleic acid.

E1S. The process of any of embodiments E1 to E14, where the reaction time period is from about 5 minutes to about 3 hours.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of this disclosure have been illustrated and described, various modifications can be made without departing from the spirit and scope of this disclosure. Accordingly, it is not intended that this disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While this disclosure has been described with respect to a number of embodiments and examples, those skilled in the art, having benefit of this disclosure, will appreciate that other embodiments can be devised which do not depart from the scope and spirit of this disclosure.

1. A composition comprising a plurality of nanoparticles, wherein each nanoparticle comprises a kernel, the kernels comprise at least one metal element and oxygen, and the kernels have an average particle size from 4 to 100 nm, and a particle size distribution of no greater than 20%.

2. The composition of claim 1, wherein the nanoparticles have an average particle size from 4 to 20 nm.

3. The composition of claim 1, wherein the nanoparticles have a size distribution of from 5 to 15 wt %.

4. The composition of claim 1, wherein the nanoparticles comprise a plurality of C14-C24 hydrophobic long-chain groups attached to the surface of the kernels.

5. The composition of claim 1, wherein the kernels comprise at least two metal elements.

6. The composition of claim 5, wherein the at least two metal elements are uniformly distributed in the nanoparticles.

7. The composition of claim 1, further comprising a solid support, wherein at least a portion of the nanoparticles are disposed on the surface of the solid support.

8. The composition of claim 1, wherein the at least one metal elements comprises a metal element M1, an optional metal element M2, and optionally a third metal element M3, M1 is selected from Mn, Fe, Co, and combination of two or more thereof in any proportion, M2 is selected from Ni, Zn, Cu, Mo, W, Ag, and M3 is selected from the lanthanides, Y, Sc, alkaline metals, group 13, 14, and 15 elements, wherein the molar ratios of M2, M3, O, S, and P, if any, to M1 is r1, r2, r3, r4 and r5, respectively, and 0≤r1≤2, 0≤r2≤2, 0≤r3≤5, 0≤r4≤5, 0≤r5≤5.

9. The composition of claim 8, wherein 0.05≤r1≤0.5, and 0.005≤r2≤0.5.

10. The composition of claim 8, wherein the kernels further comprise sulfur and the molar ratio of sulfur to M1 is r4, and 0≤r4≤2.

11. The composition of claim 8, wherein the kernels further comprise phosphorous and the molar ratio of phosphorous to M1 is r5, and 0≤r5≤2.

12. The composition of claim 1, wherein the kernels are substantially spherical in shape.

13. The composition of claim 1, wherein the kernels are rod-shaped.

14. A process for making a composition comprising a plurality of nanoparticles, wherein the nanoparticles comprise an oxide of at least one metal element, and the process comprise:
(I) providing a first dispersion system at a first temperature, the first dispersion system comprising a salt of a long-chain organic acid of the at least one metal element, a long-chain hydrocarbon solvent, optionally a salt of a second organic acid of the at least one metal element, optionally sulfur or an organic sulfur compound soluble in the long-chain hydrocarbon solvent, and optionally an organic phosphorus compound soluble in the long-chain hydrocarbon solvent; and
(II) heating the first dispersion system to a second temperature higher than the first temperature but no higher than the boiling point of the long-chain hydrocarbon solvent, where at least a portion of the salt of the long-chain organic acid and at least a portion of the salt of the second organic acid, if present, decomposes to form a second dispersion system comprising nanoparticles dispersed in the long-chain hydrocarbon solvent, and the nanoparticles comprise kernels, and the kernels comprise the at least one metal element, oxygen, optionally sulfur, and optionally phosphorus.

15. The process of claims 14, wherein the nanoparticles have an average particle size from 4 to 20 nm, and a particle size distribution of no greater than 20%.

16. The process of any of claim 14, wherein step (I) comprises:
(Ia) providing a first liquid mixture of the long-chain organic acid, the long-chain hydrocarbon solvent, and the salt of the second organic acid;
(Ib) heating the second mixture to the first temperature to obtain the first dispersion system.

17. The process of claim 16, wherein steps (Ia), (Ib), and are all performed in the same vessel.

18. The process of claim 16, wherein step (Ia) comprises:
(Ia.1) mixing the long-chain organic acid with the long-chain hydrocarbon solvent to obtain a liquid pre-mixture; and
(Ia.2) adding, to the liquid pre-mixture obtained in (Ia.1), (i) the salt of the second organic acid; (ii) optionally elemental sulfur and/or an organic-sulfur compound soluble in the long-chain hydrocarbon solvent, and (iii) optionally a phosphorous-containing organic compound soluble in the long-chain hydrocarbon solvent at the first temperature.

19. The process of claim 16, wherein in step (Ib), the first mixture is heated to a temperature no lower than the boiling point of the second organic acid or the decomposition temperature of the second organic acid, whichever is lower.

20. The process of claim 14, wherein the first dispersion system is substantially free of a surfactant other than the salt of the long-chain organic acid.

21. The process of claim 14, wherein the second temperature is at least 210° C.

22. The process of claim 14, wherein the long-chain organic acid is oleic acid, and the long-chain hydrocarbon solvent is 1-octadecene.

23. The process of claim 14, further comprising:
(III) separating the nanoparticles from the second dispersion system;
(IV) cleaning the separated nanoparticles; and
(V) dispersing the nanoparticles in a hydrophobic solvent.

24. The process of any of claim 23, further comprising:
(VI) dispersing the nanoparticles on the surface of a support; and
(VII) drying and/or calcining the support to obtain a catalyst composition comprising the support and a catalytic component comprising the at least one metal, oxygen, optionally sulfur, and optionally phosphorous.

25. A process for making a catalyst composition, the process comprising:
(A) providing the composition of claim 1;
(B) contacting the composition with a support to disperse the nanoparticles on the surface of the support; and
(C) drying and/or calcining the support after step (B) to obtain the catalyst composition comprising the support and a catalytic component on the surface of the support, the catalytic component comprising the at least one metal, oxygen, optionally sulfur, and optionally phosphorous.
